(19) United States
(12) Patent Application Publication
(10) Pub. No.: US 2026/0038812 A1
(43) Pub. Date: Feb. 5, 2026

(54) LMFP-LFP CORE-SHELL CATHODE MATERIAL

(71) Applicant: NISSAN NORTH AMERICA, INC., Franklin, TN (US)

(72) Inventors: Santhanam RAMAN, Farmington Hills, MI (US); Sandeep PATIL, Farmington Hills, MI (US); Cenk GUMECI, Northville, MI (US)

(21) Appl. No.: 18/791,368

(22) Filed: Jul. 31, 2024

(51) Int. Cl. H01M 4/36; H01M 4/02; H01M 4/58; H01M 4/62; H01M 10/052; H01M 50/417

(52) U.S. Cl. CPC H01M 4/366; H01M 4/5825; H01M 4/625; H01M 10/052; H01M 50/417; H01M 2004/021; H01M 2004/027; H01M 2004/028

(57) ABSTRACT

An electrode is provided. The electrode includes an electrode material comprising a plurality of electrode active material particles. Each of the plurality of electrode active material particles includes a core, a first coating layer formed on a first surface of the core, a shell formed on a second surface of the first coating layer, and a second coating layer formed on a third surface of the shell. The core is formed of a lithium manganese iron phosphate material having the formula LiMn_{y}Fe_{1-y}PO₄, where 0<y<1. The first coating layer includes first carbon nanofibers. The shell includes LiFePO₄. The second coating layer includes second carbon nanofibers.

### BACKGROUND

### Field of the Invention

The present invention generally relates to an electrode material for a battery, in particular a cathode material. The electrode material includes a plurality of electrode active material particles. Each of the plurality of electrode active material particles includes a core, a first coating layer formed on a first surface of the core, a shell formed on a second surface of the first coating layer, and a second coating layer formed on a third surface of the shell. The core is formed of a lithium manganese iron phosphate material having the formula LiMn_{y}Fe_{1-y}PO₄, where 0<y<1. The first coating layer includes first carbon nanofibers. The shell includes LiFePO₄, and the second coating layer includes second carbon nanofibers. The present invention also relates to a battery including the electrode material.

### Background Information

Lithium-based batteries that include lithium metal anodes or lithium-based cathode material are desirable because they have a high energy density and, thus, can generate a large amount of power with a relatively thin electrode structure, thus permitting a reduction in the size of the battery as compared with other conventional batteries including anodes made of carbon or silicon.

Lithium-based batteries that include lithium iron phosphate (LiFePO₄, “LFP”) as a cathode active material are desirable because they have a good performance at high temperatures and are less likely to experience thermal runaway and other safety issues relative to other lithium-ion cathode active materials. In addition, LFP batteries are environmentally friendly because the cathode material does not contain heavy metals such as nickel and cobalt. LFP batteries are also desirable because they have a significantly longer cycle life than lithium-ion batteries that use a lithium nickel manganese cobalt oxide (LiNiMnCoO₂, also commonly referred to as “NMC”) cathode material. Conventional LFP-based batteries include cylindrical and prismatic batteries that use a liquid electrolyte.

However, one of the primary drawbacks with conventional LFP batteries is that they have a lower energy density compared to other lithium-ion batteries. As a result, LFP batteries have a lower specific energy and require a larger physical size to achieve a given energy capacity.

In order to address these issues, it has been proposed to use lithium manganese iron phosphate (LiMnFePO₄, “LMFP”) as a cathode active material instead of LFP. LMFP batteries are desirable because they have a 15% to 30% higher energy density and lower cost than LFP batteries while maintaining the same level of safety. However, LMFP batteries have a shorter cycle life and lower charge-discharge capacity than LFP batteries due to the dissolution of manganese when the LMFP interacts with the electrolyte. The low conductivity of LMFP also makes it difficult to fully reach the theoretical capacity of LMFP.

Therefore, further improvement is needed to obtain a lithium-ion battery that is environmentally friendly and has a high energy density, low cost, high safety performance, good structural stability and good cycle performance.

### SUMMARY

It has been discovered that the high energy density, low cost and high safety performance of LMFP can be achieved while also maintaining a good structural stability and cycle performance, by providing a cathode material including an LMFP core and a LFP shell. In particular, it has been discovered that the high energy density and low cost of LMFP can be achieved while avoiding manganese dissolution by providing a LFP shell and a carbon nanofiber outer coating over the LMFP core to prevent manganese from containing the liquid electrolyte. As a result, the benefits of LFP and LMFP can be combined while avoiding the drawbacks of each.

In view of the state of the known technology, one aspect of the present disclosure is to provide an electrode for a battery. The electrode includes an electrode material comprising a plurality of electrode active material particles. Each of the plurality of electrode active material particles includes a core, a first coating layer formed on a first surface of the core, a shell formed on a second surface of the first coating layer, and a second coating layer formed on a third surface of the shell. The core is formed of a lithium manganese iron phosphate material having the formula LiMn_{y}Fe_{1-y}PO₄, where 0<y<1. The first coating layer includes first carbon nanofibers. The shell includes LiFePO₄. The second coating layer includes second carbon nanofibers.

By providing the LMFP in the inner core and surrounding the core with a LFP shell and carbon nanofiber coating layer, contact between the manganese in the cathode material and the liquid electrolyte can be avoided, thereby avoiding the undesirable dissolution of the manganese and resulting degradation in battery characteristics.

Another aspect of the present disclosure is to provide a battery. The battery includes an anode comprising an anode material, a cathode comprising a cathode material, and a separator disposed between the anode and the cathode. The cathode material includes a plurality of cathode active material particles. Each of the plurality of cathode active material particles includes a core, a first coating layer formed on a first surface of the core, a shell formed on a second surface of the first coating layer, and a second coating layer formed on a third surface of the shell. The core is formed of a lithium manganese iron phosphate material having the formula LiMn_{y}Fe_{1-y}PO₄, where 0<y<1. The first coating layer includes first carbon nanofibers. The shell includes LiFePO₄, and the second coating layer includes second carbon nanofibers.

A further aspect of the present disclosure is to provide an electrode material. The electrode material includes a plurality of electrode active material particles. Each of the plurality of electrode active material particles includes a core, a first coating layer formed on a first surface of the core, a shell formed on a second surface of the first coating layer, and a second coating layer formed on a third surface of the shell. The core is formed of a lithium manganese iron phosphate material having the formula LiMn_{y}Fe_{1-y}PO₄, where 0<y<1. The first coating layer includes first carbon nanofibers. The shell includes LiFePO₄, and the second coating layer includes second carbon nanofibers.

By providing an electrode material with LMFP in the inner core, a LFP shell surrounding the core and a carbon nanofiber outer coating layer, contact between the manganese in the cathode material and the liquid electrolyte can be avoided, thereby avoiding the undesirable dissolution of the manganese and resulting degradation in battery characteristics.

### BRIEF DESCRIPTION OF THE DRAWINGS

Referring now to the attached drawings which form a part of this original disclosure:

FIG. 1 is perspective view of a battery according to a first embodiment;

FIG. 2a is a cross-sectional view of a battery in an unwound state according to a second embodiment;

FIG. 2b is an enlarged cross-sectional view of a cathode of the battery according to the second embodiment;

FIG. 2c is an enlarged partial perspective view of a cathode material of the battery according to the second embodiment;

FIG. 3a is a partial perspective view of an electrode according to a third embodiment;

FIG. 3b is an enlarged perspective view of an electrode material of the electrode according to the third embodiment;

FIG. 3c is a partial perspective view of the electrode material of the electrode according to the third embodiment;

FIG. 4a is a partial perspective view of an electrode according to a fourth embodiment;

FIG. 4b is an enlarged perspective view of an electrode material of the electrode according to the fourth embodiment; and

FIG. 4c is a partial perspective view of the electrode material of the electrode according to the fourth embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

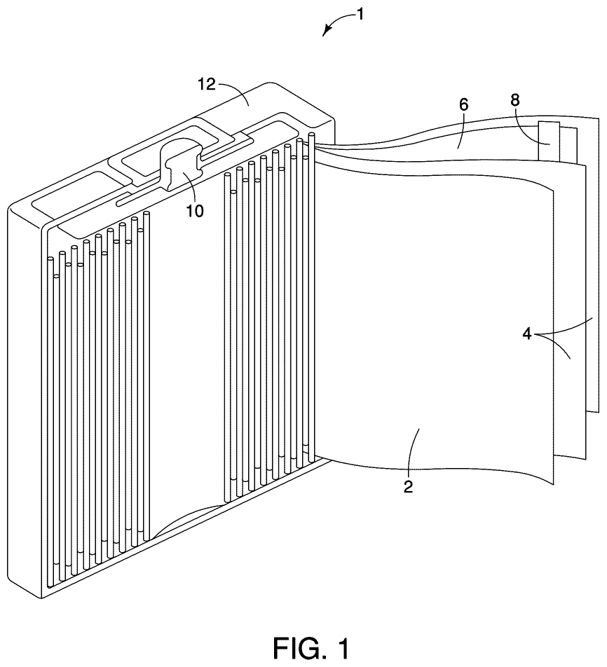

Referring initially to FIG. 1, a battery 1 is illustrated in accordance with a first embodiment. The battery 1 is a prismatic lithium-ion battery having a nonaqueous liquid electrolyte contained therein. The battery 1 can be used in a vehicle, an energy storage system, a laptop computer, a mobile device or other suitable personal electronic device.

As shown in FIG. 1, the battery 1 includes a cathode 2, separators 4, an anode 6, an anode tab 8, a cathode tab 10, and a battery case 12. The battery 1 also includes a nonaqueous liquid electrolyte (not shown). Any suitable nonaqueous liquid electrolyte may be used. For example, the electrolyte includes at least one lithium salt, such as lithium hexafluorophosphate (LiPF₆) and/or lithium bis(trifluoromethanesulfonyl)imide (“Li-TFSI”), and at least one solvent. The at least one solvent includes ethylene carbonate (“EC”), diethylene carbonate (“DEC”), dimethyl carbonate (“DMC”), ethylmethyl carbonate (“EMC”), or mixtures thereof. The electrolyte can optionally include at least one additive such as vinylene carbonate (“VC”), fluoroethylene carbonate (“FEC), and propane sultone (“PS”).

The cathode 2 includes a cathode material disposed on a cathode current collector. The cathode current collector is formed of any suitable metal, such as aluminum or copper, preferably aluminum. The cathode 2 has a thickness of approximately 150 μm to 500 μm.

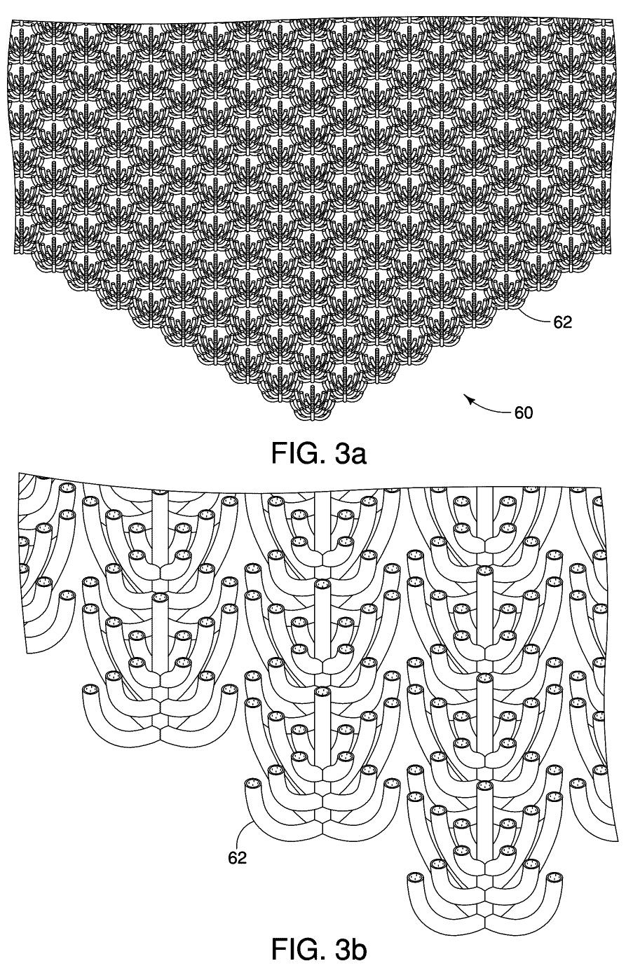

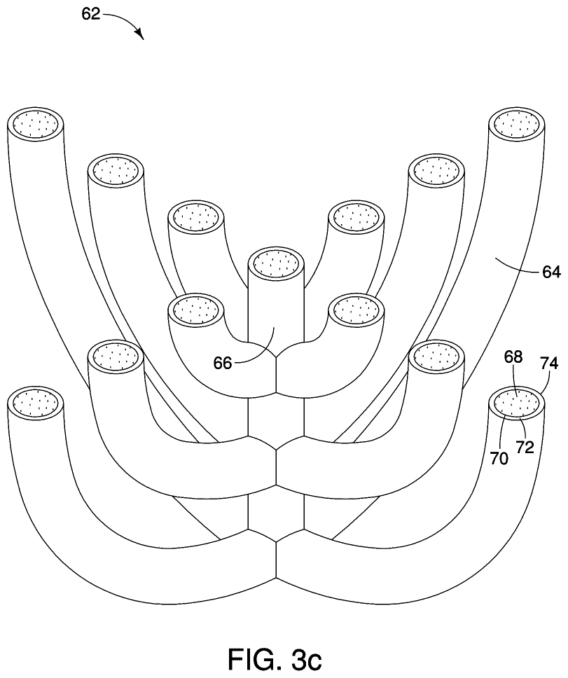

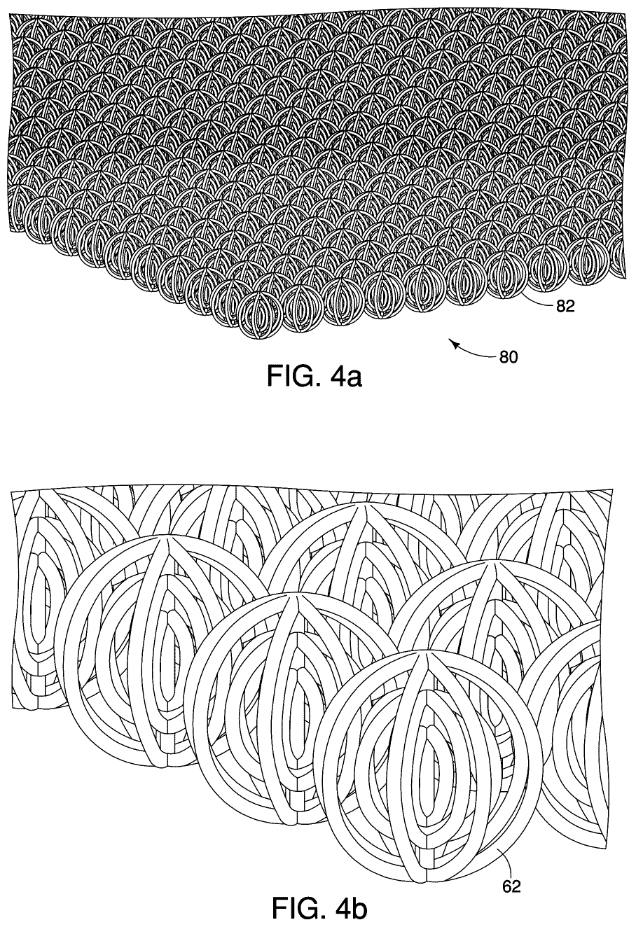

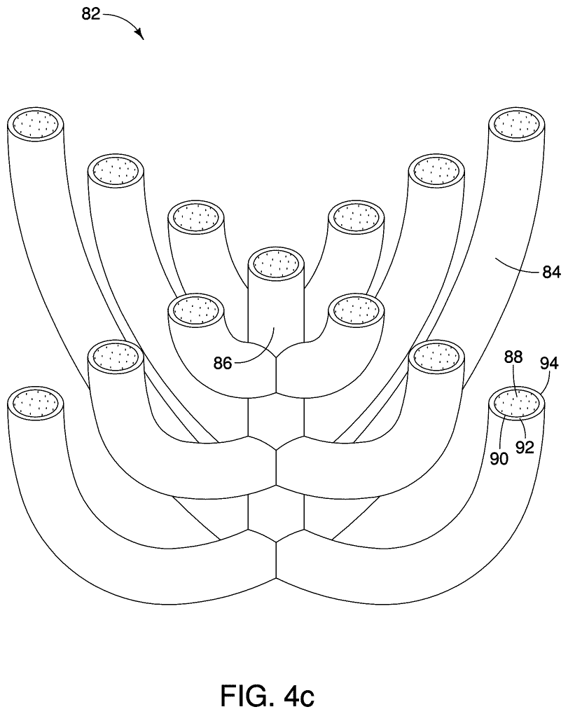

The cathode material includes cathode active material particles each having a core, a first coating layer, a shell and a second coating layer. The shape of the particles will be described in further detail below with reference to FIGS. 3a-4c. The core includes a LMFP material having the formula LiMn_{y}Fe_{1-y}PO₄, where 0<y<1. The core has a size or diameter of approximately 5 μm to 10 μm. The LMFP core is formed by any suitable method, such as solid state, co-precipitation, or a sol-gel method.

The first coating layer is formed on an outer surface of the core and has a thickness of approximately 50 nm to 100 nm. The first coating layer includes carbon nanofibers. The carbon nanofibers can be coated on the LMFP core in any suitable manner. For example, the carbon nanofibers may be spray coated on the LMFP core or slurry coated on the LMFP core using a doctor blade.

The shell is formed on an outer surface of the first coating layer and has a thickness of 0.5 μm to 1 μm. The shell includes LiFePO₄ (LFP) and carbon nanofibers. The shell can be coated on the first coating layer in any suitable manner. For example, the shell can be slurry coated on the first coating layer using a doctor blade by dispersing the carbon nanofibers and LFP in a solvent such as N-methylpyrrolidone (“NMP”) and casting the slurry onto the first coating layer.

The second coating layer is formed on an outer surface of the shell and has a thickness of 50 nm to 100 nm. The second coating layer includes carbon nanofibers and preferably has a same composition as the first coating layer. The carbon nanofibers can be coated on the shell in any suitable manner. For example, the carbon nanofibers may be spray coated on the shell or slurry coated on the shell using a doctor blade.

The cathode material can also optionally include a binder and/or an additive. The cathode material includes approximately 0% to 2% by weight of the binder relative to a total weight of the cathode material. The cathode material preferably includes 0% by weight of the binder. The binder can be any suitable electrode binder material. For example, the binder can include polyvinylidene fluoride (“PVDF”), polyvinyl alcohol, polyacrylic acid or a mixture thereof. The cathode material includes approximately 0% to 2% by weight of the additive. The additive can be any suitable sacrificial electrode additive.

The separators 4 are formed of any suitable material configured to hold a liquid electrolyte. For example, the separators 4 are each formed of polyethylene and/or polypropylene. The separators 4 have a thickness of approximately 8 μm to 15 μm.

The anode 6 includes an anode material disposed on an anode current collector. The anode current collector is formed of any suitable metal, such as aluminum or copper, preferably copper. The anode 6 has a thickness of approximately 70 μm to 250 μm.

The anode material includes an anode active material. The anode active material can be any suitable anode active material for a lithium-ion battery, such as graphite, silicon, a silicon-graphite composite, lithium titanium oxide (“LTO”), lithium metal, graphene, a composite of silicon and graphene oxide, or a lithium metal alloy.

The anode material can also optionally include a binder and/or an additive. The anode material includes approximately 1% to 2% by weight of the binder relative to a total weight of the cathode material. The cathode 2 preferably includes 0% by weight of the binder. The binder can be any suitable electrode binder material. For example, the binder can include PVDF, SBR, CMC, PTFE, Nafion, or a mixture thereof. The cathode 2 includes approximately 1% to 4% by weight of the additive. The additive can be any suitable sacrificial electrode additive, such as carbon, carbon nanotubes, carbon nanofibers, graphene, a graphene oxide-graphene composite, graphene nanotubes, or a mixture thereof.

The anode tab 8 and the cathode tab 10 are formed of any suitable electrode terminal materials, such as a metal, an alloy or a carbon material. The battery case 12 is formed of any suitable material, such as aluminum.

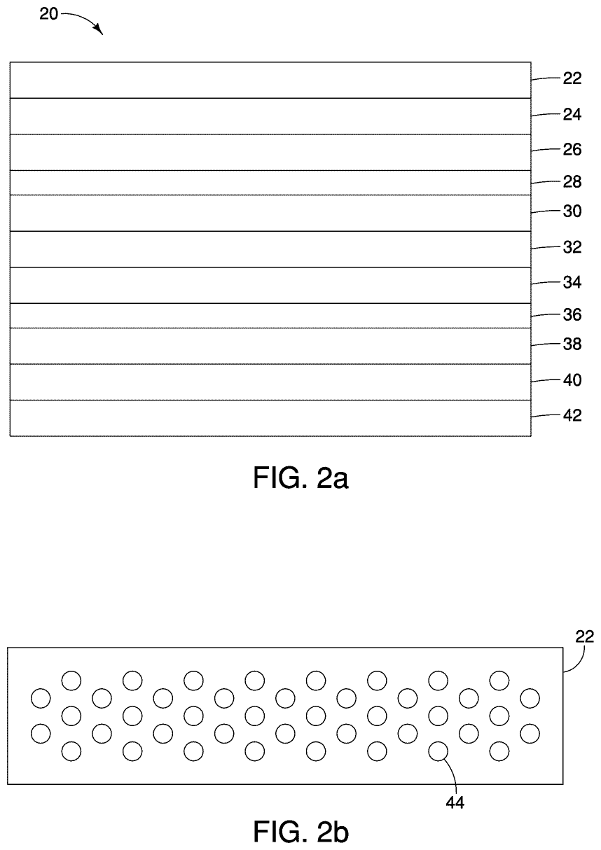

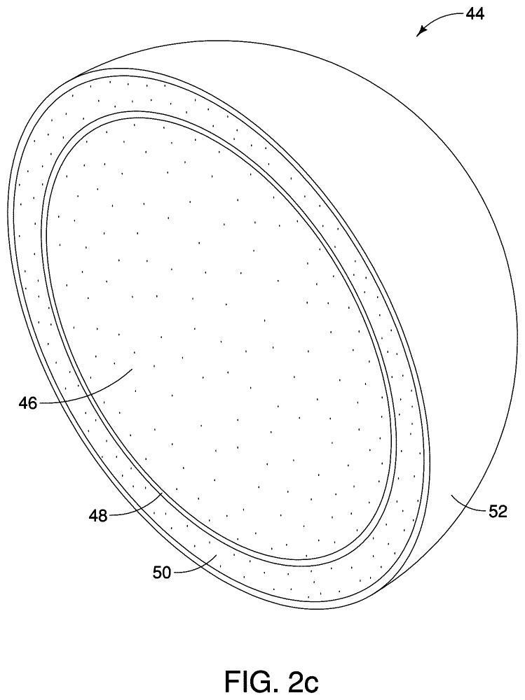

FIG. 2a shows a cross-sectional view of a battery 20 in an unwound state according to a second embodiment. The battery 20 can be any suitable lithium-ion battery having a nonaqueous liquid electrolyte contained therein. For example, the battery 20 can be a prismatic battery or a cylindrical battery. The battery 20 can be used in a vehicle, an energy storage system, a laptop computer, a mobile device or other suitable personal electronic device.

As shown in FIG. 2a, the battery 20 includes a cathode 22, a separator 24, an anode 26, an anode current collector 28, an anode 30, a separator 32, a cathode 34, a cathode current collector 36, a cathode 38, a separator 40 and an anode 42.

The cathodes 22, 34 and 38 are all the same. Therefore, discussion of cathodes 34 and 38 will be omitted, since the description of cathode 22 also applies to cathodes 34 and 38. As shown in FIG. 2b, the cathode 22 includes a plurality of cathode active material particles 44. The cathode 2 has a thickness of approximately 150 μm to 500 μm.

FIG. 2c shows a partial perspective view of the cathode active material particles 44. As shown in FIGS. 2b and 2c, the cathode active material particles 44 have a spherical shape. However, it should be understood that the cathode active material particles 44 can have any suitable shape, such as a semi-circular shape as described in detail below with respect to FIGS. 3a-3c.

The cathode active material particles 44 each include a core 46, a first coating layer 48, a shell 50 and a second coating layer 52. The core 46 includes a LMFP material having the formula LiMn_{y}Fe_{1-y}PO₄, where 0<y<1. The core 46 has a size or diameter of approximately 5 μm to 10 μm. The core 46 is formed by any suitable method, such as solid state, co-precipitation, or a sol-gel method.

The first coating layer 48 is formed on an outer surface of the core 46 as shown in FIG. 2c. The first coating layer 48 has a thickness of approximately 50 nm to 100 nm. The first coating layer 48 includes carbon nanofibers. The carbon nanofibers can be coated on the core 46 in any suitable manner. For example, the carbon nanofibers may be spray coated on the core 46 or slurry coated on the core 46 using a doctor blade to form the first coating layer 48.

The shell 50 is formed on an outer surface of the first coating layer and has a thickness of 0.5 μm to 1 μm. The shell 50 includes LiFePO₄ (LFP) and carbon nanofibers. The shell 50 can be coated on the first coating layer in any suitable manner. For example, the materials in the shell 50 can be slurry coated on the first coating layer 48 using a doctor blade by dispersing the carbon nanofibers and LFP in a solvent such as NMP and casting the slurry onto the first coating layer 48 to form the shell 50.

As shown in FIG. 2c, the second coating layer 52 is formed on an outer surface of the shell 50. The second coating layer 52 has a thickness of 50 nm to 100 nm. The second coating layer 52 includes carbon nanofibers and preferably has a same composition as the first coating layer 48. The carbon nanofibers can be coated on the shell 50 in any suitable manner. For example, the carbon nanofibers may be spray coated on the shell 50 or slurry coated on the shell 50 using a doctor blade to form the second coating layer 52.

The cathode 22 can also optionally include a binder and/or an additive. The cathode 22 includes approximately 0% to 2% by weight of the binder relative to a total weight of the cathode. The cathode 22 preferably includes 0% by weight of the binder. The binder can be any suitable electrode binder material. For example, the binder can include PVDF, polyvinyl alcohol, polyacrylic acid or a mixture thereof. The cathode 22 includes approximately 0% to 2% by weight of the additive. The additive can be any suitable sacrificial electrode additive.

By providing the LMFP in the core 46, the first carbon nanofiber coating layer 48, the LFP shell 50 and a second carbon nanofiber coating layer 52, the high energy density and safety of the LMFP can be utilized while avoiding contact between the manganese in the LMFP and the liquid electrolyte. As a result, the undesirable dissolution of the manganese can be avoided and the battery 20 can have both a good cycle life and good charge-discharge capabilities.

The separators 24, 32 and 40 are the same and are each formed of any suitable material configured to hold a liquid electrolyte. For example, the separators 24, 32 and 40 are each formed of polyethylene and/or polypropylene. The separators 24, 32 and 40 each have a thickness of approximately 8 μm to 15 μm.

The anodes 26, 30 and 42 are the same and each have a thickness of approximately 70 μm to 250 μm. The anodes 26, 30 and 42 each include an anode material comprising an anode active material. The anode active material can be any suitable anode active material for a lithium-ion battery, such as graphite, silicon, a silicon-graphite composite, LTO, lithium metal, graphene, silicon-graphene oxide composite, or a lithium metal alloy.

The anode material can also optionally include a binder and/or an additive. The anode material includes approximately 1% to 2% by weight of the binder relative to a total weight of the cathode material. The cathode 2 preferably includes 0% by weight of the binder. The binder can be any suitable electrode binder material. For example, the binder can include PVDF, SBR, CMC, PTFE, Nafion, or a mixture thereof. The cathode 2 includes approximately 1% to 4% by weight of the additive. The additive can be any suitable sacrificial electrode additive, such as carbon, carbon nanotubes, carbon nanofibers, graphene, a graphene oxide-graphene composite, graphene nanotubes, or a mixture thereof.

The anode current collector 28 is formed of any suitable metal, such as aluminum or copper, preferably copper. The cathode current collector 36 is formed of any suitable metal, such as aluminum or copper, preferably aluminum.

FIGS. 3a-3c show an electrode 60 for a battery. The battery can be any suitable lithium-ion battery having a nonaqueous liquid electrolyte contained therein. For example, the battery can be a prismatic battery or a cylindrical battery. The battery can be used in a vehicle, an energy storage system, a laptop computer, a mobile device or other suitable personal electronic device.

The electrode 60 includes a plurality of electrode active material particles 62. The electrode 60 has a thickness of approximately 150 μm to 500 μm. The electrode 60 in this embodiment is a cathode, and the electrode active material particles 62 are cathode active material particles.

As shown in FIGS. 3b and 3c, the electrode active material particles 62 have a semi-circular shape with semi-circular shaped branches 64 extending out from a central cylindrical stem 66. This semi-circular shape is desirable because it allows the electrode active material particles 62 to better adapt to membrane stresses during battery cycling, thereby allowing the electrode 60 to incur higher stresses during expansion without damaging the electrode. This also allows the electrode 60 to have a greater thickness than conventional cathodes, which generally have a thickness of 100 μm or less. However, it should be understood that the electrode active material particles 62 can have any suitable shape, such as a spherical shape as described in detail below with respect to FIGS. 4a-4c. This semi-circular shape can be formed by any suitable method, such as 3D printing.

The electrode active material particles 62, including both the branches 64 and the stem 66, each include a core 68, a first coating layer 70, a shell 72 and a second coating layer 74. The core 68 includes a LMFP material having the formula LiMn_{y}Fe_{1-y}PO₄, where 0<y<1. The core 68 has a size or diameter of approximately 5 μm to 10 μm. The core 68 is formed by any suitable method, such as solid state, co-precipitation, or a sol-gel method.

The first coating layer 70 is formed on an outer surface of the core 68. The first coating layer 70 has a thickness of approximately 50 nm to 100 nm. The first coating layer 70 includes carbon nanofibers. The carbon nanofibers can be coated on the core 68 in any suitable manner. For example, the carbon nanofibers may be spray coated on the core 68 or slurry coated on the core 68 using a doctor blade to form the first coating layer 70.

As shown in FIG. 3c, the shell 72 is formed on an outer surface of the first coating layer 70 and has a thickness of 0.5 μm to 1 μm. The shell 50 includes LiFePO₄ (LFP) and carbon nanofibers. The shell 50 can be coated on the first coating layer in any suitable manner. For example, the materials in the shell 72 can be slurry coated on the first coating layer 70 using a doctor blade by dispersing the carbon nanofibers and LFP in a solvent such as NMP and casting the slurry onto the first coating layer 70 to form the shell 72.

The second coating layer 74 is formed on an outer surface of the shell 72. The second coating layer 74 has a thickness of 50 nm to 100 nm. The second coating layer 74 includes carbon nanofibers and preferably has a same composition as the first coating layer 70. The carbon nanofibers can be coated on the shell 72 in any suitable manner. For example, the carbon nanofibers may be spray coated on the shell 72 or slurry coated on the shell 72 using a doctor blade to form the second coating layer 74.

The electrode 60 can also optionally include a binder and/or an additive. The electrode 60 includes approximately 0% to 2% by weight of the binder relative to a total weight of the electrode. The electrode 60 preferably includes 0% by weight of the binder. The binder can be any suitable electrode binder material. For example, the binder can include PVDF, polyvinyl alcohol, polyacrylic acid or a mixture thereof. The electrode 60 includes approximately 0% to 2% by weight of the additive. The additive can be any suitable sacrificial electrode additive.

By providing the core 68 including LMFP, the first carbon nanofiber coating layer 70, the LFP shell 72 and a second carbon nanofiber coating layer 74, the high energy density and safety of the LMFP can be utilized while avoiding contact between the manganese in the LMFP and the liquid electrolyte. As a result, the undesirable dissolution of the manganese can be avoided and a battery including the electrode 60 can have both a good cycle life and good charge-discharge capabilities.

FIGS. 4a-4c show an electrode 80 for a battery. The battery can be any suitable lithium-ion battery having a nonaqueous liquid electrolyte contained therein. For example, the battery can be a prismatic battery or a cylindrical battery. The battery can be used in a vehicle, an energy storage system, a laptop computer, a mobile device or other suitable personal electronic device.

The electrode 80 includes a plurality of electrode active material particles 82. The electrode 80 has a thickness of approximately 150 μm to 500 μm. The electrode 80 in this embodiment is a cathode, and the electrode active material particles 82 are cathode active material particles.

As shown in FIGS. 4b and 4c, the electrode active material particles 82 have a spherical shape with circular branches 84 surrounding and being connected to a central cylindrical stem 86. This spherical shape is desirable because it allows the electrode active material particles 82 to better adapt to membrane stresses during battery cycling, thereby allowing the electrode 80 to incur higher stresses during expansion without damaging the electrode. This also allows the electrode 80 to have a greater thickness than conventional cathodes, which generally have a thickness of 100 μm or less. However, it should be understood that the electrode active material particles 82 can have any suitable shape, such as a semi-circular shape as described above with respect to FIGS. 3a-3c. The spherical shape can be formed by any suitable method, such as 3D printing.

The electrode active material particles 82, including both the circular branches 84 and the stem 86, each include a core 88, a first coating layer 90, a shell 92 and a second coating layer 94. The core 88 includes a LMFP material having the formula LiMn_{y}Fe_{1-y}PO₄, where 0<y<1. The core 88 has a size or diameter of approximately 5 μm to 10 μm. The core 88 is formed by any suitable method, such as solid state, co-precipitation, or a sol-gel method.

The first coating layer 90 is formed on an outer surface of the core 88. The first coating layer 90 has a thickness of approximately 50 nm to 100 nm. The first coating layer 90 includes carbon nanofibers. The carbon nanofibers can be coated on the core 88 in any suitable manner. For example, the carbon nanofibers may be spray coated on the core 88 or slurry coated on the core 88 using a doctor blade to form the first coating layer 90.

As shown in FIG. 4c, the shell 92 is formed on an outer surface of the first coating layer 90 and has a thickness of 0.5 μm to 1 μm. The shell 92 includes LiFePO₄ (LFP) and carbon nanofibers. The shell 50 can be coated on the first coating layer in any suitable manner. For example, the materials in the shell 92 can be slurry coated on the first coating layer 90 using a doctor blade by dispersing the carbon nanofibers and LFP in a solvent such as NMP and casting the slurry onto the first coating layer 90 to form the shell 92.

The second coating layer 94 is formed on an outer surface of the shell 92. The second coating layer 94 has a thickness of 50 nm to 100 nm. The second coating layer 94 includes carbon nanofibers and preferably has a same composition as the first coating layer 90. The carbon nanofibers can be coated on the shell 92 in any suitable manner. For example, the carbon nanofibers may be spray coated on the shell 92 or slurry coated on the shell 92 using a doctor blade to form the second coating layer 94.

The electrode 80 can also optionally include a binder and/or an additive. The electrode 80 includes approximately 0% to 2% by weight of the binder relative to a total weight of the electrode. The electrode 80 preferably includes 0% by weight of the binder. The binder can be any suitable electrode binder material. For example, the binder can include PVDF, polyvinyl alcohol, polyacrylic acid or a mixture thereof. The electrode 80 includes approximately 0% to 2% by weight of the additive. The additive can be any suitable sacrificial electrode additive.

By providing the LMFP core 88, the first carbon nanofiber coating layer 90, the LFP shell 92 and a second carbon nanofiber coating layer 94, the high energy density and safety of the LMFP can be utilized while avoiding contact between the manganese in the LMFP and the liquid electrolyte. As a result, the undesirable dissolution of the manganese can be avoided and a battery including the electrode 80 can have both a good cycle life and good charge-discharge capabilities.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “substantially”, “about” and “approximately” as used herein, mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. An electrode comprising:
an electrode material comprising a plurality of electrode active material particles,
each of the plurality of electrode active material particles comprising:
a core formed of a lithium manganese iron phosphate material having the formula LiMn_{y}Fe_{1-y}PO₄, where 0<y<1;
a first coating layer formed on a first surface of the core, the first coating layer comprising first carbon nanofibers;
a shell formed on a second surface of the first coating layer, the shell comprising LiFePO₄; and
a second coating layer formed on a third surface of the shell, the second coating layer comprising second carbon nanofibers.

2. The electrode according to claim 1, wherein
the shell further comprises third carbon nanofibers.

3. The electrode according to claim 1, wherein
the core has a size of 5 μm to 10 μm.

4. The electrode according to claim 1, wherein
the electrode has a thickness of 150 μm to 500 μm.

5. The electrode according to claim 1, wherein
the electrode material further includes a binder in an amount of less than 2% by weight relative to a total weight of the electrode material.

6. The electrode according to claim 1, wherein
each of the plurality of electrode active material particles has a semi-circular shape in which curved branches extend from a central cylindrical portion.

7. The electrode according to claim 1, wherein
each of the first coating layer and the second coating layer has a thickness of 50 nm to 100 nm.

8. The electrode according to claim 1, wherein
the shell has a thickness of 0.5 μm to 1 μm.

9. A battery comprising:
an anode comprising an anode material:
a cathode comprising a cathode material; and
a separator disposed between the anode and the cathode,
the cathode material comprising a plurality of cathode active material particles, and each of the plurality of cathode active material particles comprising:
a core formed of a lithium manganese iron phosphate material having the formula LiMn_{y}Fe_{1-y}PO₄, where 0<y<1;
a first coating layer formed on a first surface of the core, the first coating layer comprising first carbon nanofibers;
a shell formed on a second surface of the first coating layer, the shell comprising LiFePO₄; and
a second coating layer formed on a third surface of the shell, the second coating layer comprising second carbon nanofibers.

10. The battery according to claim 9, wherein
the core has a size of 5 μm to 10 μm.

11. The battery according to claim 9, wherein
the cathode has a thickness of 150 μm to 500 μm.

12. The battery according to claim 9, wherein
the cathode material further includes a binder in an amount of less than 2% by weight relative to a total weight of the cathode material.

13. The battery according to claim 9, wherein
each of the plurality of cathode active material particles has a semi-circular shape in which curved branches extend from a central cylindrical portion.

14. The battery according to claim 9, wherein
each of the first coating layer and the second coating layer has a thickness of 50 nm to 100 nm.

15. The battery according to claim 9, wherein
the shell has a thickness of 0.5 μm to 1 μm.

16. The battery according to claim 9, wherein
the anode comprises an anode active material selected from the group consisting of: graphite, silicon, a silicon-graphite composite, lithium metal, lithium titanium oxide, graphene, a composite of silicon and graphene oxide, and a lithium metal alloy.

17. The battery according to claim 9, wherein
the anode has a thickness of 70 μm to 250 μm.

18. The battery according to claim 9, further comprising
a liquid electrolyte provided in the separator.

19. The battery according to claim 9, wherein
the separator is formed of at least one selected from the group consisting of: polyethylene and polypropylene.

20. An electrode material comprising:
a plurality of electrode active material particles,
each of the plurality of electrode active material particles comprising:
a core formed of a lithium manganese iron phosphate material having the formula LiMn_{y}Fe_{1-y}PO₄, where 0<y<1;
a first coating layer formed on a first surface of the core, the first coating layer comprising first carbon nanofibers;
a shell formed on a second surface of the first coating layer, the shell comprising LiFePO₄; and
a second coating layer formed on a third surface of the shell, the second coating layer comprising second carbon nanofibers.
